(19) United States
(12) Patent Application Publication
(10) Pub. No.: US 2009/0103564 A1
(43) Pub. Date: Apr. 23, 2009

(54) Method and apparatus for controlling media access in sensor network

(75) Inventors: Kyeseon Lee, Daejeon-city (KR); Se Han Kim, Daejeon-city (KR); Chong-Ho Yoon, Seoul (KR); Gang-Ho Byun, Seoul (KR); Nae-Soo Kim, Daejeon-city (KR); Cheol Sig Pyo, Daejeon-city (KR)

Correspondence Address: STAAS & HALSEY LLP, SUITE 700, 1201 NEW YORK AVENUE, N.W., WASHINGTON, DC, 20005, US

(73) Assignees: Electronics and Telecommuniations Research Institute, Daejeon (KR); Industry-University Cooperation Foundation Korea Aerospace University, Goyang (KR)

(21) Appl. No.: 12/149,519

(22) Filed: May 2, 2008

(30) Foreign Application Priority Data
Oct. 19, 2007 (KR) 10-2007-0105756

(51) Int. Cl. H04J 3/22

(52) U.S. Cl. 370/470

(57) ABSTRACT

Provided are a method and apparatus for controlling media access in a sensor network and a method of managing traffic information. Since traffic information is exchanged between nodes and data is transmitted by using a dynamic long preamble according to receiver nodes, data transmission efficiency can be improved, energy consumed to transmit the long preamble can be reduced, and data transmission delay can be reduced as well.

### CROSS-REFERENCE TO RELATED PATENT APPLICATION

This application claims the benefit of Korean Patent Application No. 10-2007-0105756, filed on Oct. 19, 2007, in the Korean Intellectual Property Office, the disclosure of which is incorporated herein in its entirety by reference.

### BACKGROUND OF THE INVENTION

1. Field of the Invention

The present invention relates to a method and apparatus for controlling media access in a sensor network, and more particularly, to a method and apparatus for controlling media access in a sensor network in which a node notifies its own traffic information to neighbouring nodes, collects and stores traffic information of the neighbouring nodes in a table, and communicates by using a dynamic long preamble on the basis of the traffic information stored in the table.

The present invention is derived from a research project supported by the Information Technology (IT) Research & Development (R&D) program of the Ministry of Information and Communication (MIC) and the Institute for Information Technology Advancement (IITA) [2005-S-106-03, Development of Sensor Tag and Sensor Node Techniques for RFID/USN].

2. Description of the Related Art

A sensor network consists of sensor nodes and a sink node wherein the sensor nodes transmit information obtained by sensors to the sink node with the ability to collect data. Accordingly, most of sensor networks exhibit a tree topology in which a sink node collects data from a plurality of sensor nodes.

The most frequent communication pattern observed within such sensor networks is an upward communication pattern in which information is forwarded to the sink node which is a root node in a tree structure. Accordingly, the present invention provides a method and apparatus for controlling media access in a sensor network exhibiting a tree topology which can reduce energy consumption and transmission delay in an environment where an upward communication pattern is most frequently used.

In a conventional art, nodes wake up at constant intervals called check intervals at different points in time and perform a low power listening (LPL) operation in order to check whether a channel is being used. The check intervals may be set to any one of 10, 20, 50, 100, 200, 400, 800, and 1600 ms. A sender node having data to be transmitted confirms that the channel is in an idle mode by performing an LPL operation, and transmits a long preamble having a length greater than the check interval in order to notify neighbouring nodes capable of reception that the sender node has the data to be transmitted. The long preamble includes consecutively connected short preambles each including a preamble, a start frame delimiter (SFD), a destination address (DA), a remainder of preamble, and a data length. The sender node transmits the data to be transmitted after the transmission of the long preamble.

The neighbouring nodes of the sender node wake up at check intervals to perform an LPL operation, receive the short preambles included in the long preamble, and determine whether the neighbouring nodes are receiver nodes by using the DA. If it is determined that the neighbouring nodes are the receiver nodes, the neighbouring nodes maintain a sleep mode for a duration corresponding to a remainder of the long preamble to reduce energy consumption, and when the sender node transmits the data, wake up to receive the data. If it is determined that the neighbouring nodes are not the receiver nodes, the neighbouring nodes maintain a sleep mode for a duration corresponding to a sum of a remainder of the long preamble and a data transmission time to reduce energy consumption.

However, the conventional art uses the check intervals and preambles having the same length. Accordingly, in an environment where a node at a higher hierarchical level processes greater traffic, for example, in a tree topology where a sink node collects data, when a lower node processing less traffic load and an upper node processing greater traffic have the same check interval, unnecessary energy consumption and data transmission delay are caused.

### SUMMARY OF THE INVENTION

The present invention provides a method of controlling media access in a sensor network which can reduce unnecessary energy consumption and also reduce data transmission delay which occurs between hops.

To this end, since the method based on an asynchronous protocol dynamically uses a preamble notifying that there is data to be transmitted according to the amount of traffic processed by neighbouring nodes, energy consumed to transmit or overhear the preamble can be reduced and transmission delay during the transmission of the preamble can be reduced.

Other objects and advantages of the present invention will become more apparent by describing in detail exemplary embodiments thereof with reference to the attached drawings. Also, it is to be easily understood that the objects and advantages of the present invention could be realized through means and combinations thereof shown in the claims.

According to an aspect of the present invention, there is provided a method of controlling media access in a sensor network including a plurality of nodes transmitting and receiving information by using a long preamble consisting of consecutive short preambles, the method comprising: when a first node, among the nodes checking a channel usage state at different intervals, senses that there is no valid signal in a channel and has data to be transmitted, determining a length of the long preamble on the basis of traffic information on one or more receiver nodes among the nodes; consecutively generating one or more short preambles corresponding to the determined length of the long preamble according to a type of the data to be transmitted; and transmitting the short preambles to the receiver nodes.

According to another aspect of the present invention, there is provided a method of controlling media access in a sensor network including a plurality of nodes transmitting and receiving information by using a long preamble consisting of consecutive short preambles, the method comprising: at a first node sensing that there is a valid signal in a channel among the nodes checking a channel usage state at different intervals, receiving a short preamble transmitted by a second node emitting the valid signal among the nodes; maintaining a sleep mode for a duration corresponding to a remainder of the long preamble at a time position of the short preamble; and when the sleep mode duration is passed, acquiring data from the short preambles generated according to a type of data to be transmitted, wherein the second node determines a total length of the long preamble on the basis of traffic information of its neighbouring nodes.

According to another aspect of the present invention, there is provided a method of controlling media access in a sensor network including sensor nodes transmitting and receiving information by using a long preamble consisting of consecutive short preambles, the method comprising: sensing whether there is a valid signal in a channel by checking a channel usage state at first channel check intervals; when there is no valid signal in the channel, requesting downward traffic to neighbouring nodes by using a long preamble with a greatest length among usable preamble lengths; receiving a short preamble including the downward traffic from a neighbouring node receiving a short preamble of the long preamble with the greatest length; and setting a second channel check interval by using the downward traffic and upward traffic.

According to another aspect of the present invention, there is provided a method of controlling media access of a sensor node in a sensor network including sensor nodes transmitting and receiving information by using a long preamble consisting of consecutive short preambles, the method comprising: checking a state of a channel at predetermined channel check intervals by using downward traffic and upward traffic obtained from neighbouring nodes; receiving short preambles in the channel and checking traffic information of the short preambles; when the traffic information is a message for requesting downward traffic, transmitting the downward traffic by using a long preamble with a length greater than a channel check interval of a node requesting the downward traffic having the same type of short preamble; and when the traffic information is change information of the upward traffic or the downward traffic, resetting the channel check interval.

According to another aspect of the present invention, there is provided an apparatus for controlling media access in a sensor network including sensor nodes transmitting and receiving information by using a long preamble consisting of consecutive short preambles, the apparatus comprising: a monitor sensing whether there is a valid signal in a channel by checking a channel usage state at predetermined intervals; a preamble generating unit determining, when there is no valid signal in the channel and there is data to be transmitted, a length of the long preamble on the basis of traffic information of one or more receiver nodes and consecutively generating one or more short preambles corresponding to the determined length of the long preamble according to a type of the data to be transmitted; and a transmitting unit transmitting the short preambles to the receiver nodes.

The apparatus may further comprise: a receiving unit receiving a short preamble transmitted by a node emitting the valid signal to the channel; and a parsing unit maintaining a sleep mode for a duration corresponding to a remainder of the long preamble at a time position of the short preamble, and when the sleep mode duration is passed, acquiring data transmitted according to a type of the short preamble, wherein a total length of the long preamble is determined by the node emitting the valid signal on the basis of traffic information of its neighbouring nodes.

According to another aspect of the present invention, there is provided a computer-readable recording medium having embodied thereon a program for executing a method of controlling media access in a sensor network.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates a tree topology in which traffic generated by nodes and upwardly transmitted traffic are aggregated and processed according to an embodiment of the present invention;

FIG. 2 illustrates traffic tables respectively owned by the nodes of FIG. 1 according to an embodiment of the present invention;

FIG. 3 illustrates a structure of a long preamble used to transmit transmission data according to an embodiment of the present invention;

FIG. 4 illustrates a structure of a long preamble used to exchange traffic information according to an embodiment of the present invention;

FIGS. 5A and 5B show a flowchart illustrating a method of transmitting traffic of nodes, and registering and updating traffic tables according to an embodiment of the present invention;

FIG. 6 illustrates operations of some of the nodes of the tree topology of FIG. 1 according to an embodiment of the present invention;

FIGS. 7A and 7B show a flowchart illustrating a method of transmitting and receiving a preamble (message) of a node according to an embodiment of the present invention; and

FIG. 8 is a block diagram of an apparatus for controlling media access of node in a sensor network according to an embodiment of the present invention.

### DETAILED DESCRIPTION OF THE INVENTION

The present invention will now be described more fully with reference to the accompanying drawings, in which exemplary embodiments of the invention are shown. In the drawings, whenever the same element reappears in a subsequent drawing, it is denoted by the same reference numeral. Detailed explanation will not be given when it is determined that detailed explanation about well-known function and configuration of the present invention may dilute the point of the present invention.

Unless the context dictates otherwise, the word “comprise” or variations such as “comprises” or “comprising” is understood to mean “includes, but is not limited to” such that other elements that are not explicitly mentioned may also be included.

The present invention relates to a method by which a node can notify its own traffic information to neighbouring nodes by efficiently using a preamble used in media access control (MAC) of an asynchronous sensor network, collect and store traffic information of the neighbouring nodes in a table, and communicate by using a dynamic long preamble.

A conventional technique uses a long preamble with a fixed length that is not suitable for a sensor network topology forming a tree pattern. To solve the problem, the present invention uses a long preamble with a dynamic length on the basis of traffic information, thereby improving data transmission efficiency and reducing energy consumed to transmit the long preamble.

The present invention provides a method of exchanging traffic information, a method of storing the traffic information in a table, and a method of efficiently configuring a long preamble. Accordingly, since the traffic information is exchanged and the long preamble is dynamically used according to a receiver node, energy consumption and data transmission delay can be reduced.

According to the present invention, each node exchanges its own traffic information with an upper node and lower nodes through a traffic field of a short preamble, and forms a traffic table on the basis of the exchanged traffic information. The length of a long preamble used during transmission on the basis of the traffic table varies depending on a receiver node. The long preamble includes one or more consecutive short preambles.

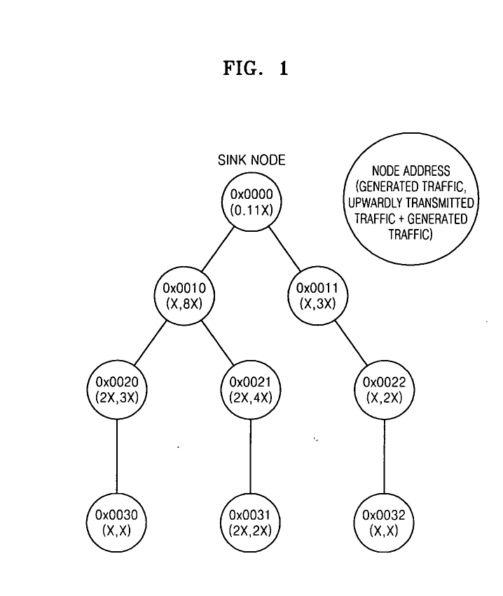

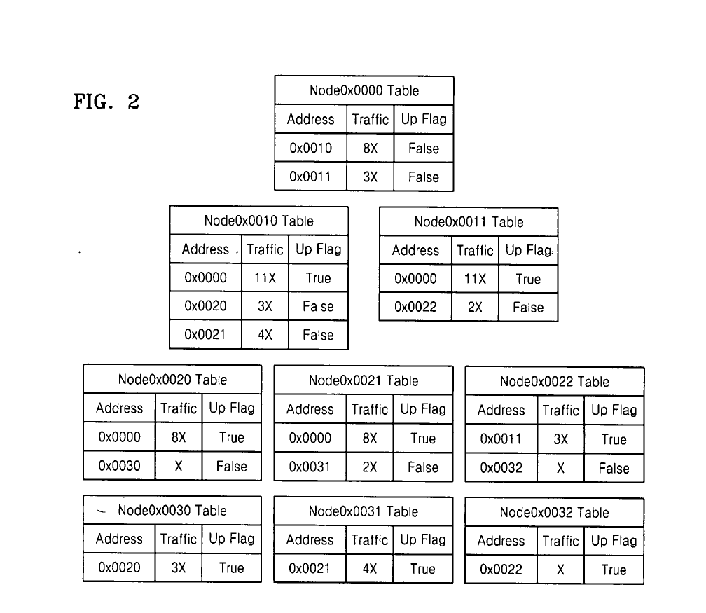

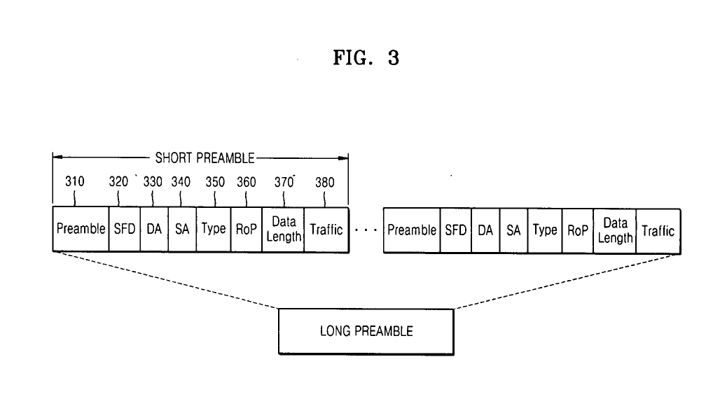

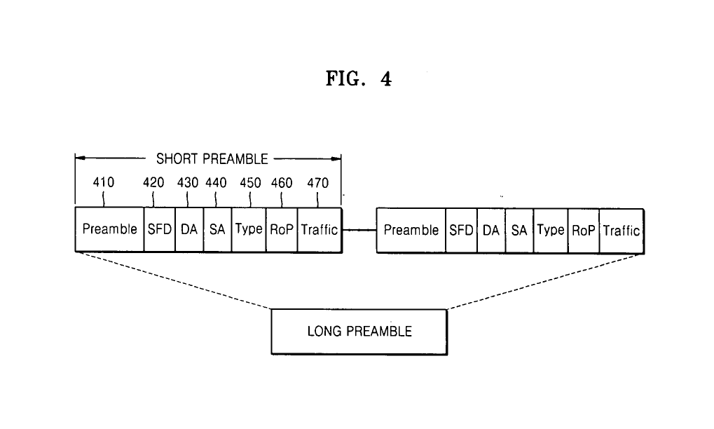

FIG. 1 illustrates a tree topology in which traffic generated by nodes and upwardly transmitted traffic are aggregated and processed according to an embodiment of the present invention. FIG. 2 illustrates traffic tables respectively owned by the nodes of FIG. 1 according to an embodiment of the present invention. FIG. 3 illustrates a structure of a long preamble used to transmit transmission data according to an embodiment of the present invention. FIG. 4 illustrates a structure of a long preamble used to exchange traffic information according to an embodiment of the present invention Referring to FIG. 1, each of the nodes constituting the tree topology is represented with a node address and traffic information in parentheses. The traffic information identified by the right number in the parentheses is traffic generated by the node and the traffic information identified by the left number in the parentheses is traffic obtained by summing the traffic generated by the node and traffic received from lower nodes and upwardly transmitted. It is assumed that a root node of the tree topology is a sink node 0x0000, and traffic periodically generated by the sink node 0x0000 is already known because all nodes exchange downward traffic information. The downward traffic is a sum of traffic, which the sink node periodically generates and transmits to lower nodes, and non-periodic traffic. The downward traffic is denoted by Y. Also, all the nodes already know their lower nodes and upper nodes connected in the tree topology. In FIG. 1, the downward traffic is not shown and only the traffic periodically transmitted to the sink node, such as the traffic generated by each node and the upwardly transmitted traffic are shown.

Referring to FIG. 2, each of the traffic tables includes an address of a target node, traffic information of the target node, and a flag indicating whether a node is an upper node or a lower node in level. The traffic information of the target node, that is, traffic information of an upper node or a lower node in the tree topology, is updated by receiving a short preamble of the upper node or the lower node. The traffic information of the target node is an upward traffic value transmitted by the target node. When an up flag value is true, a node is an upper node, and when an up flag value is false, a node is a lower node. It can be understood by one of ordinary skill in the art that other methods than the present embodiment can be used to indicate the hierarchical level of a node.

When a node needs to transmit traffic information, the node transmits the traffic information by using a long preamble with a least length which a receiver node can sufficiently receive by calculating a check interval on the basis of traffic information of the receiver node.

Referring to FIG. 3, the long preamble used to transmit transmission data includes one or more consecutive short preambles. Each of the short preambles includes a preamble field 310, a start frame delimiter (SFD) field 320, a destination address (DA) field 330, a source address field 340, a type field 350, a remainder of preamble (ROP) field 360, a data length field 370, and a traffic field 380.

The preamble field 310 is a field required for bit synchronization.

The SFD field 320 is a field indicating the start of information in byte units.

The DA field 330 is a field indicating an address of a receiver node.

The SA field 340 is a field indicating an address of a sender node.

The type field 350 is a field indicating a type of a short preamble. The long preamble of FIG. 3 used to transmit the transmission data uses a type of 0.

The ROP field 360 is a field indicating a remainder of the long preamble at a time position of a short preamble received by the receiver node.

The data length field 370 is a field indicating a length of transmission data transmitted subsequent to the long preamble.

The traffic field 380 is a field indicating upward traffic which is a sum of generated traffic which the node periodically reports to a sink node and upwardly transmitted traffic which is transmitted from lower nodes to an upper node. A traffic field 470 of the long preamble of FIG. 4 used to exchange traffic information may indicate downward traffic.

Referring to FIG. 4, the long preamble used to update or exchange traffic information includes one or more short preambles each consisting of a preamble field 410, an SFD field 420, a DA field 430, an SA field 440, a type field 450, an ROP field 460, and a traffic field 470. Since the short preamble of FIG. 4 is used to exchange only traffic information, unlike the short preamble of FIG. 3, the short preamble of FIG. 4 does not include a data length field and there is no transmission data transmitted subsequent to the long preamble.

The preamble field 410 is a field required for bit synchronization.

The SFD field 420 is a field indicating the start of information in byte units.

The DA field 430 is a field indicating an address of a receiver node.

The SA field 440 is a field indicating an address of a sender node transmitting the long preamble.

The type field 450 is a field indicating a type of a short preamble, and the receiver node can determine whether the long preamble is used to transmit transmission date or to exchange traffic information by using a value of the type field 450. When the long preamble is used to exchange traffic information, the value of the type field may be set to 1, 2, or 3. For example, when the type field has a value of 1, the long preamble may be used to request downward traffic information to neighbouring nodes or respond to neighbouring nodes. When the type field 450 has a value of 2, the long preamble may be used to initially register or update upward traffic information. When the type field 450 has a value of 3, the long preamble may be used to update downward traffic information.

The ROP field 460 is a field indicating a remainder of the long preamble.

The traffic field 470 is a field indicating downward traffic information or upward traffic information and includes the traffic information to be exchanged or updated. Here, upward traffic is a sum of generated traffic which a sensor node periodically transmits to a sink node, and upwardly transmitted traffic which is transmitted from lower nodes to an upper node. Downward traffic is a sum of traffic which a sink node periodically transmits to all lower nodes, and traffic which the sink node non-periodically generates. The amount of the traffic which the sink node periodically transmits to all the lower nodes is constant while the amount of the upward traffic gets bigger by collecting information of lower nodes. Traffic which may be non-periodically generated by each node is traffic information for improving data transmission efficiency. When the type field 450 of the short preamble has a value of ‘1’ and the traffic field 470 has a value of ‘0’, the long preamble may be used as a message requesting downward traffic information from the neighbouring nodes.

Referring to FIGS. 1 through 4, the node 0x0030 of FIG. 1 periodically generates traffic of X. The node 0x0030 checks its own table of FIG. 2, confirms that it has no lower nodes and upwardly transmitted traffic is 0, writes upward traffic of X on the traffic field of the short preamble of FIG. 3 used to transmit transmission data, and transmits the long preamble. The node 0x0030 performs lower power listening (LPL) by determining its own check interval on the basis of a sum of its own upward traffic of X and downward traffic of Y.

The node 0x0020 of FIG. 1 writes 3X obtained by summing traffic of 2X which the node 0x0020 generates and upwardly transmitted traffic of X received from the node 0x0030 which is its lower node in its own table of FIG. 2 in the traffic field of the short preamble of FIG. 3 used to transmit transmission data and transmits the long preamble. The node 0x0020 performs LPL by determining its own check interval on the basis of a sum of its own upward traffic of 3X and downward traffic of Y.

The node 0x0010 of FIG. 1 writes 8X obtained by summing traffic of X which the node 0x0010 generates and upward traffic 3X and 4X received from the nodes 0x0020 and 0x0021 which are its lower nodes in its own table of FIG. 2 in the traffic field of the short preamble of FIG. 3 used to transmit transmission data and transmits the long preamble. The node 0x0010 performs LPL by determining its own channel check interval on the basis of a sum of its own upward traffic of 8X and downward traffic of Y.

All the other nodes fills the traffic fields of the short preambles used to transmit transmission data by referring to their own traffic tables. As described above, since the traffic field of the long preamble used to transmit transmission data is filled with upward traffic information and then transmitted, receiver nodes or neighbouring nodes receiving the traffic field of the long preamble can be aware of the upward traffic information, such that check intervals of the neighbouring nodes can be known by considering downward traffic information.

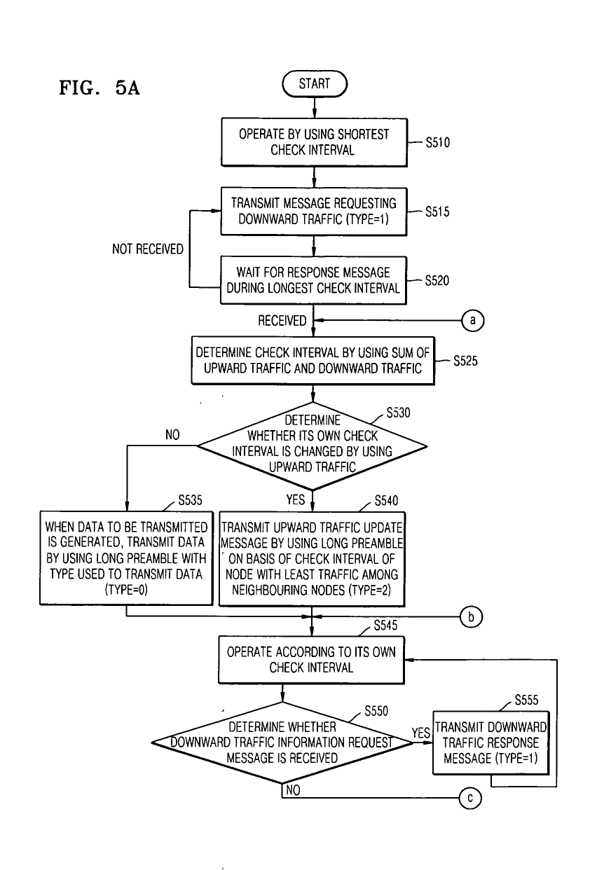

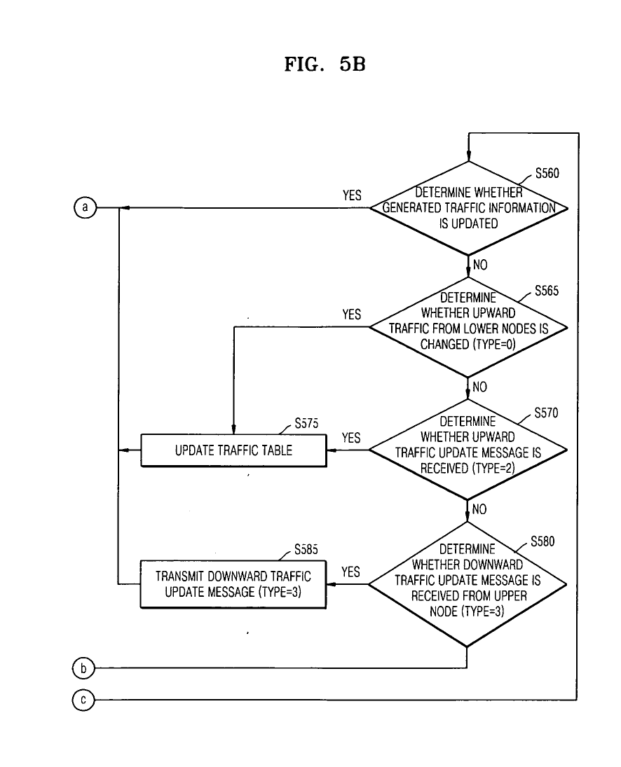

FIGS. 5A and 5B show a flowchart illustrating a method of transmitting traffic of nodes, and registering and updating traffic tables according to an embodiment of the present invention. In FIGS. 5A and 5B, a process for nodes to join a network will not be explained. For convenience, one first node among a plurality of sensor nodes will be exemplarily explained.

Referring to FIGS. 5A and 5B, a process for the first node joining the network to transmit a downward traffic information request message will be first explained. In operation S510, since a check interval of the first node is not determined yet, the first node wakes up at check intervals of 10 ms which is a shortest check interval among usable check intervals and performs LPL.

In operation S515, since the first node joining the network has no downward traffic information and thus has not determine its own check interval, in order to obtain the downward traffic information, the first node transmits a long preamble having a structure used to exchange traffic information as shown in FIG. 4 to neighbouring nodes and requests the downward traffic information. Referring to FIG. 4, the first node fills its own address in the SA field 440 of the short preamble, ‘1’ in the type field 450, ‘0’ in the traffic field 470, and a remainder of the long preamble at a time position of the short preamble in the ROP field 450, and transmits a long preamble with a greatest length of 1600 ms or more.

In operation S520, since LPL cycles of the neighbouring nodes are not known, the first node waits for a downward traffic response message during a longest check interval among usable check intervals and checks whether the response message is received. Until the response message is received, the first node repeats operations 515 and 520.

A receiver node receiving a message requesting the downward traffic information checks the values of the type field 450 and the traffic field 470 of the received short preamble and determines whether the message is a message for transmitting data, a message requesting downward traffic information, or a traffic update message. Referring to FIG. 4, when the value of the type field 450 is ‘1’ and the value of the traffic field 470 is ‘0’, the receiver node recognizes that the message is a message requesting the downward traffic information, determines a sleep mode duration by referring to the value of the ROP field 460, and maintains a sleep mode for the sleep mode duration. In order to prevent collisions after waking up from the sleep mode, the receiver node is waiting during a random backoff time ranging from 0 to 6 ms, then fills ‘1’ in the type field 450 and downward traffic information in the traffic field of the preamble structure of FIG. 4 by using a long preamble with a length greater than 10 ms, and responds to the downward traffic information request of the first node.

In operation S525, the first node receiving the downward traffic information determines its own check interval by summing the amount of generated traffic which the first node periodically reports to a sink node, the amount of upwardly transmitted traffic which is transmitted from its own lower nodes to an upper node, and the amount of downward traffic. As a traffic value is high, the amount of traffic to be processed is high and thus a check interval with a small length is used. When a traffic value is low, a check interval with a great length is used. Once the first node determines its own check interval, the first node initially transmits its own traffic information to neighbouring nodes by using the long preamble with the greatest length of 1600 ms or more.

In operation S530, the first node determines whether its own check interval is changed by upward traffic.

When it is determined in operation S530 that the check interval is not changed, the method proceeds to operation S535. In operation S535, when there is transmission data to be transmitted, the first node transmits the transmission data and its own upward traffic information to the neighbouring nodes by using a long preamble with a type of ‘0’ used to transmit transmission data.

When it is determined in operation S530 that the check interval is changed, the method proceeds to operation S540. Neighbouring nodes directly communicating with the first node should know the changed check interval of the first node. Accordingly, in operation S540, the first node transmits an upward traffic update message by using a long preamble with a type of ‘2’ according to a check interval of a node with least traffic by referring to its own traffic table.

In operation S545, the first node repeats LPL according to its own check interval.

A process for the first node operating according to its own check intervals to receive and update a downward traffic information request message will now be explained.

In operation S550, the first node repeating LPL according to its own check interval checks whether a received message is a downward traffic information request message. Referring to FIG. 4, when the value of the type field 450 is ‘1’ and the value of the traffic field 470 is ‘0’, the first node may recognize that the received message is a downward traffic information request message.

When it is checked in operation S550 that the received message is the downward traffic information request message, the method proceeds to operation S555. In operation S555, the first node fills ‘1’ in the type field 450 and downward traffic information in the traffic field 470 of the preamble structure of FIG. 4 and responds to a sender node transmitting the downward traffic information request message.

When the message is not a downward traffic information request message, or when a downward traffic information request message is not received, the first node determines whether the amount of traffic which the first node processes is changed. The amount of the traffic which the first node processes may be changed when the amount of traffic which the first node generates is changed, the amount of traffic transmitted from lower nodes is changed, or the amount of downward traffic is changed.

In operation S560, the first node determines whether the amount of traffic which the first node generates is changed. When the amount of the traffic which the first node generates is changed, the method returns to operation S525. In operation S525, the first node redetermines its own check interval.

When it is determined in operation S560 that the generated traffic is not changed, the method proceeds to operation S565. In operation S565, the first node determines whether upward traffic from lower nodes is changed by using the received message. That is, when the received message has a type of ‘0’, whether upward traffic is changed is determined by using a traffic field of the message transmitted from the lower nodes. When it is determined in operation S565 that the upward traffic is changed, the method proceeds to operation S575. In operation S575, the first node updates its own traffic table according to the changed upward traffic. In operation S525, the first node redetermines its own check interval by using the changed upward traffic.

When it is determined in operation S565 that the upward traffic is not changed, the method proceeds to operation S570. In operation S570, the first node determines whether the received message is an upward traffic update message from the lower nodes. When the received message has a type of ‘2’, the upward traffic is updated and thus the method proceeds to operation S575. In operation S575, the first node updates its own traffic table according to the updated upward traffic. In operation S525, the first node redetermines its own check interval by using the updated upward traffic.

When it is determined in operation S570 that the received message is not an upward traffic update message, method proceeds to operation S580. In operation S580, the first node determines whether the received message is a downward traffic update message from an upper node. When it is determined in operation S580 that the received message is a downward traffic update message, the method proceeds to operation S585. When the received message has a type of ‘3’, downward traffic is updated. In operation S585, the first node transmits a downward traffic update message having a type of ‘3’ in order to notify the lower nodes that the downward traffic is updated. The first node redetermines its own check interval by using the updated downward traffic. When a check interval is changed due to downward traffic, since a downward traffic update message is transmitted and downward traffic information of the lower nodes is updated before the changed check interval is applied, a traffic table does not need to be considered.

The order of checking the types of 0 through 3 for the received message in operations S550 through S585 may be varied.

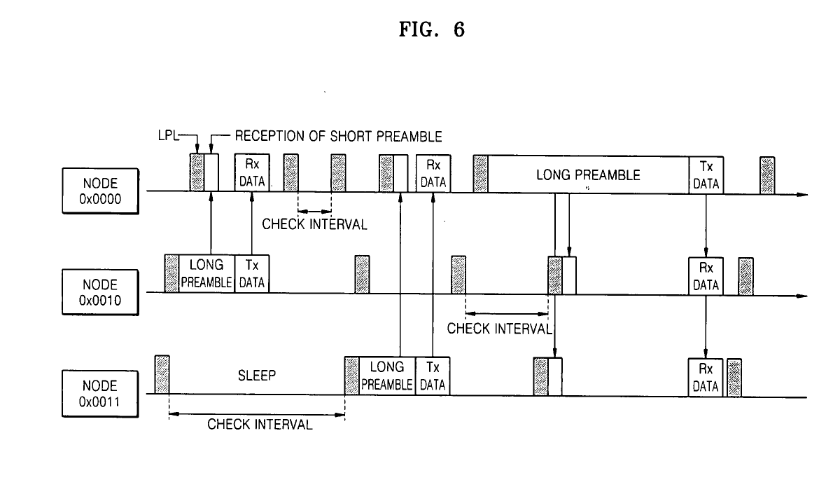

FIG. 6 illustrates operations of the nodes 0x0000, 0x0010, and 0x0011 of the tree topology of FIG. 1 according to an embodiment of the present invention.

The nodes 0x0000, 0x0010, and 0x0011 have their own traffic tables of FIG. 2, upwardly transmitted traffic values, and check intervals different from one another. As is assumed above, all nodes are aware of downward traffic of Y. The node 0x0010 and the node 0x0011 cannot communicate with each other.

The node 0x0010 checks whether there is a valid signal in a channel through LPL in order to transmit data to the node 0x0000. When it is checked that there is no valid signal, the node 0x0010 determines a check interval by using a value obtained by summing upwardly transmitted traffic of 11× of the node 0x0000 and the downward traffic of Y on the basis of its own traffic table, and transmits data by using a long preamble with a length greater than the check interval.

The node 0x0000 repeats LPL and sleep operations according to its own check interval, and when sensing that there is a valid signal in a channel during the LPL operation, turns on a radio and receives a short preamble transmitted by the node 0x0010 for a predetermined period of time. The node 0x0000 maintains a sleep mode for a duration corresponding to a value of an ROP field of the short preamble, wakes up from the sleep mode, and receives data transmitted subsequent to a long preamble. The node 0x0010 and the node 0x0000 complete communications and repeat LPL and sleep operations according to their own check intervals.

The node 0x0011 performs LPL in order to transmit data to the node 0x0000, and when sensing that there is no valid signal in a channel, the node 0x0011 determines a check interval by using a value obtained by summing the upwardly transmitted traffic of 11X of the node 0x0000 and the downward traffic of Y on the basis of its own traffic table, and transmits data by using a long preamble with a length greater than the check interval. When the node 0x0000 repeats sleep and LPL operations according to its own check interval and detects that there is a valid signal in a channel during the LPL operation, the node 0x0000 turns on a radio and receives a short preamble transmitted by the node 0x0011 for a predetermined period of time. The node 0x0000 maintains a sleep mode for a duration corresponding to a value of an ROP field of the short preamble, wakes up from the sleep mode, and then receives data transmitted subsequent to a long preamble. The node 0x0011 and the node 0x0000 complete communications and repeat LPL and sleep operations according to their own check intervals.

When the node 0x0000 transmits data to lower nodes, the node 0x0000 checks that there is no valid signal in a channel through LPL. Next, the node 0x0000 checks its own traffic table, and transmits data by using a long preamble with a length which the node 0x0011 with less traffic than the lower node 0x0010 can sufficiently receive. The nodes 0x0010 and 0x0011 repeat sleep and LPL operations according to their own check intervals, receive a short preamble of the long preamble transmitted by the node 0x0000, maintain a sleep mode for a duration corresponding to an ROP field of the short preamble, wake up from the sleep mode, and receive data transmitted subsequent to the long preamble.

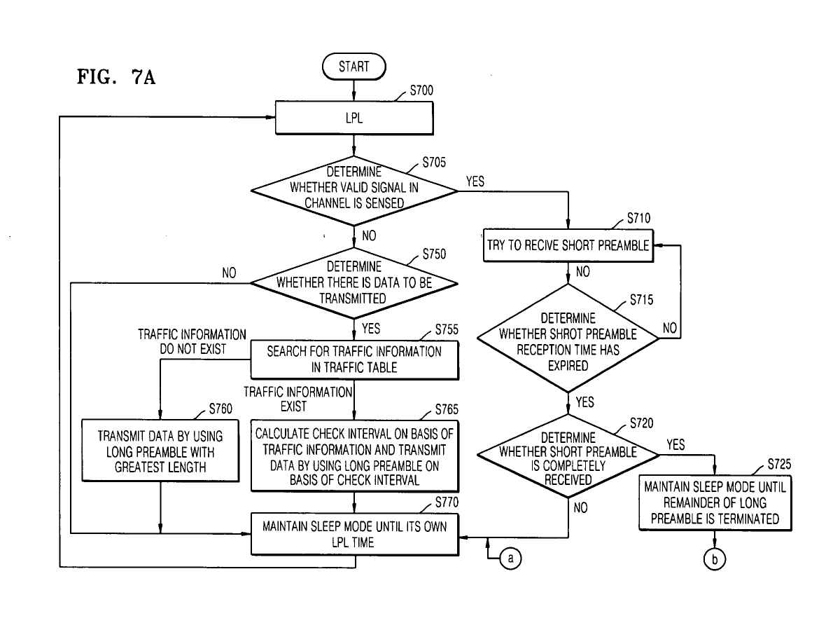

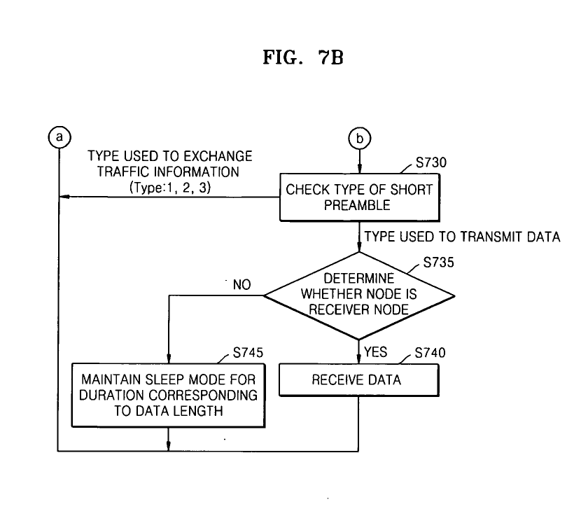

FIGS. 7A and 7B show a flowchart illustrating a method of transmitting and receiving a preamble (message) of a node according to an embodiment of the present invention.

Referring to FIGS. 7A and 7B, in operation S700, the node performs a sleep operation according to its own check interval, wakes up from a sleep mode, and performs an LPL operation.

In operation S705, the node determines whether there is a valid signal in a channel through the LPL operation.

When it is determined in operation S705 that there is a valid signal in a channel, the method proceeds to operation S710. In operation S710, the node tries to receive a short preamble.

In operation S715, the node maintains a reception mode for a reception time necessary to sufficiently receive the short preamble and determines whether the reception time has expired. When it is determined in operation S715 that the reception time has not expired, the method returns to operation S710 in which the node continues to try to receive the short preamble. When it is determined in operation S715 that the reception time has expired, the method proceeds to operation S720. In operation S720, the node determines whether the short preamble is completely received.

When it is determined in operation S720 that the short preamble is not completely received even after the reception time has expired, the method proceeds to operation S770. In operation S770, the node maintains a sleep mode until a next LPL time.

When the node receives the short preamble within the reception time, the method proceeds to operation S725. In operation S725, the node maintains a sleep mode for a duration corresponding to a value of an ROP field in order to prevent overhearing with respect to a long preamble.

In operation S730, the node checks a type of the received short preamble. When the type of the short preamble is not ‘0‘but ’1, 2, or 3’, there is no data transmitted subsequent to the preamble, and thus the method proceeds to operation S770. In operation S770, the node receives only traffic information in a traffic field according to the type and maintains a sleep mode until a next LPL time. When the short preamble has a type of ‘0’, the method proceeds to operation S735. In operation S735, the node checks whether the node is a receiver node by using a DA field.

When it is determined in operation S735 that the node is a receiver node, the method proceeds to operation S740. In operation S740, the node receives data. When it is determined in operation S735 that the node is not a receiver node, the method proceeds to operation S745. In operation S745, the node maintains a sleep mode further for a duration corresponding to a data length in order to prevent overhearing during data transmission.

When it is determined in operation S705 that there is no valid signal in a channel after the LPL operation, the method proceeds to operation S750. In operation S750, the node determines whether there is data to be transmitted or traffic information.

When it is determined in operation S750 that there is data to be transmitted or traffic information, the method proceeds to operation S755. In operation S755, the node searches for traffic information in its own traffic table.

When the traffic information is not found in the traffic table, the method proceeds to operation S760. In operation S760, the node transmits transmission information to a receiver node by using a long preamble with a greatest length of 1600 ms or more.

When the traffic information is found in the traffic table, the method proceeds to operation S765. In operation S765, the node calculates a check interval of the receiver node on the basis of downward traffic information shared by other nodes and registered upward traffic information and transmits transmission information by using a long preamble with a length which the receiver node can receive.

In operation S770, the node transmitting the transmission information maintains a sleep mode until a next LPL time.

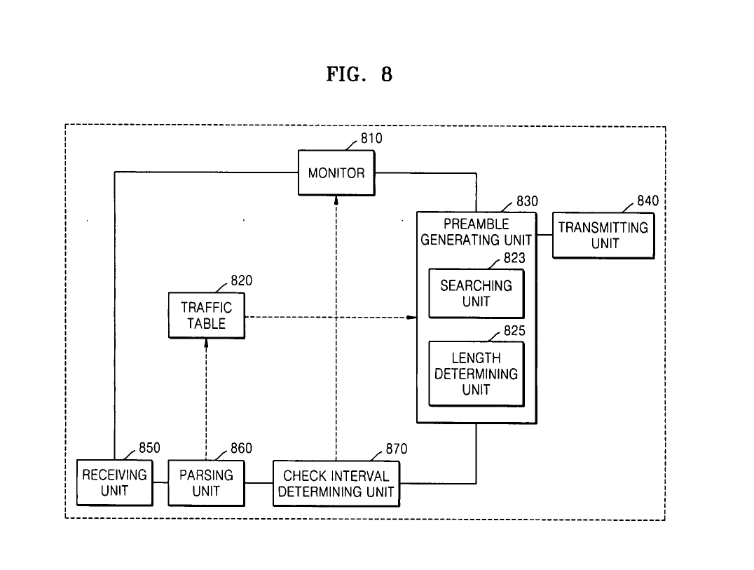

FIG. 8 is a block diagram of an apparatus for controlling media access of a node in a sensor network according to an embodiment of the present invention. In the following, repeated explanation will not be given of overlapped features.

Referring to FIG. 8, the apparatus includes a monitor 810, a traffic table 820, a preamble generating unit 830, a transmitting unit 840, a receiving unit 850, a parsing unit 860, and a check interval determining unit 870.

The monitor 810 senses whether there is a valid signal in a channel by checking a channel usage state at predetermined check intervals. The channel check intervals may vary depending on nodes. The monitor 810 transmits the channel check result to the preamble generating unit 830 and the receiving unit 850 to transmit or receive data.

The traffic table 820 is a table in which a sender node matches traffic information of neighbouring nodes with node addresses and hierarchical level information (upper or lower node information). The traffic information is upward traffic information of the neighbouring nodes.

When the monitor 820 checks that there is no valid signal in the channel and there is data to be transmitted, the preamble generating unit 830 checks traffic information of receiver nodes from the traffic table 820 and consecutively generates short preambles of a type determined by the data to be transmitted according to a length of a long preamble to be transmitted. When the data to be transmitted is transmission data, the preamble generating unit 830 generates short preambles as shown in FIG. 3, and when the data to be transmitted is traffic information to be exchanged or updated, the preamble generating unit generates short preambles as shown in FIG. 4.

The preamble generating unit 830 includes a searching unit 823 and a length determining unit 825. The searching unit 823 searches for the traffic information of the receiver nodes in the traffic table 820. When there is no traffic information of the receiver nodes in the traffic table 820, the length determining unit 825 determines a greatest length among usable preamble lengths as the length of the long preamble. When there is the traffic information of the receiver nodes in the traffic table 820, the length determining unit 825 calculates a channel check interval of a node with least traffic among the receiver nodes and determines the length of the long preamble according to the calculated channel check interval.

The transmitting unit 840 transmits the consecutive short preambles to the receiver nodes.

When the monitor 810 checks that there is a valid signal in the channel, the receiving unit 850 receives one of a plurality of short preambles consecutively transmitted from a sender node emitting the valid signal to the channel. The short preambles transmitted from the sender node are short preambles consecutively generated corresponding to a length of a long preamble which is determined by the sender node on the basis of traffic information of neighbouring nodes recorded in a traffic table of the sender node.

The parsing unit 860 parses a field of the short preamble received from the sender node and checks a type of the short preamble and a length of a remainder of a long preamble, etc. The parsing unit 860 maintains the node in a sleep mode for a duration corresponding to the remainder of the long preamble, and obtains data transmitted according to the type of the short preamble after the sleep mode duration is passed. For example, when the short preamble is used to exchange and update traffic information, the parsing unit 860 obtains traffic information from a traffic field of the short preamble and maintains a sleep mode until its own LPL time. When the short preamble is used to transmit transmission data, the parsing unit 860 receives transmission data transmitted subsequent to the long preamble. At this time, the parsing unit 860 checks whether a destination address in the short preamble is its own address, and when it is checked that the destination address is not its own address, maintains the sleep mode further for a duration corresponding to a length of the transmission data and when the destination address is its own address, receives and obtains the transmission data.

Upward traffic or downward traffic is changed according to the short preamble parsing result of the parsing unit 860, the check interval determining unit 870 resets and changes a channel check interval on the basis of the changed traffic. When the upward traffic is changed, the check interval determining unit 870 updates the traffic information of the traffic table 820. When the channel check interval is changed due to the upward traffic, the node generates and transmits a short preamble to neighbouring nodes to notify the change of the upward traffic. The monitor 810 monitors a channel state at the changed channel check intervals.

The present invention may be embodied as computer-readable codes on a computer-readable recording medium. The computer-readable recording medium is any data storage device that can store data which can be thereafter read by a computer system. Examples of the computer-readable recording medium include read-only memories (ROMs), random-access memories (RAMs), CD-ROMs, magnetic tapes, floppy disks, and optical data storage devices. The computer-readable recording medium can be dispersively installed in a computer system connected to a network, and stored and executed as a computer-readable code in a distributed computing environment. Embodiments of the present invention may be embodied as a medium (media) having a computer-readable code embodied therein for causing a number of computer systems connected via a network to effect distributed processing. Functional programs, codes, and code segments for embodying the present invention may be easily deducted by programmers in the art which the present invention belongs to.

Most of sensor networks each consisting of a plurality of sensor nodes and a sink node have a communication pattern in which information sensed by the sensor nodes is transmitted to the sink node. Accordingly, a node, closer to the sink node in a tree topology, should process greater traffic. According to the present invention, since a node with greater traffic has a check interval with a less length so as to fast process data and a node with less traffic has a check interval with a greater length so as not to unnecessarily wake up, energy consumption can be reduced.

Also, since lower nodes which are the most part in the network transmit data to upper nodes by using a long preamble with a small length, energy consumption can be reduced as compared with a method using a long preamble with a great length.

While the present invention has been particularly shown and described with reference to exemplary embodiments thereof using specific terms, it will be understood by those of ordinary skill in the art that various changes in form and details may be made therein without departing from the spirit and scope of the present invention as defined by the following claims.

While the present invention has been particularly illustrated and described with reference to exemplary embodiments thereof using specific terms, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A method of controlling media access in a sensor network including a plurality of nodes transmitting and receiving information by using a long preamble consisting of consecutive short preambles, the method comprising:
when a first node, among the nodes checking a channel usage state at different intervals, senses that there is no valid signal in a channel and has data to be transmitted, determining a length of the long preamble on the basis of traffic information on one or more receiver nodes among the nodes;
consecutively generating one or more short preambles corresponding to the determined length of the long preamble according to a type of the data to be transmitted; and
transmitting the short preambles to the receiver nodes.

2. The method of claim 1, wherein the determining of the length of the long preamble comprises:
at the first node, searching for the traffic information of the receiver nodes in a traffic table in which traffic information of neighbouring nodes among the nodes is matched with node addresses and hierarchical level information and then stored;
when the traffic information of the receiver nodes is not found in the traffic table, determining a greatest length among usable preamble lengths as a length of the long preamble; and
when the traffic information of the receiver nodes is found in the traffic table, determining a length of the long preamble on the basis of a channel check interval of a receiver node with least traffic.

3. The method of claim 1, wherein the generating of the one or more short preambles comprises
when the data to be transmitted is traffic information to be exchanged or updated, generating short preambles each including the traffic information to be exchanged or updated.

4. The method of claim 3, wherein the traffic information is upward traffic, which is a sum of traffic which is transmitted from lower nodes to an upper node and traffic which the first node generates, or downward traffic, which is a sum of traffic which is periodically transmitted from a sink node to lower nodes and non-periodic traffic which is generated by the sink node.

5. The method of claim 1, wherein the generating of the one or more short preambles comprises
when the data to be transmitted is transmission data to be transmitted subsequent to the long preamble, generating short preambles each including a length of the transmission data.

6. The method of claim 5, wherein the traffic information is upward traffic that is a sum of traffic which is transmitted from lower nodes to an upper node and traffic which the first node generates.

7. The method of claim 5, wherein, when the first node is a sink node, the traffic information includes traffic which is periodically transmitted from the sink node to lower nodes.

8. The method of claim 2, wherein the traffic table is updated by traffic information of neighbouring nodes obtained from short preambles received from the neighbouring nodes.

9. A method of controlling media access in a sensor network including a plurality of nodes transmitting and receiving information by using a long preamble consisting of consecutive short preambles, the method comprising:
at a first node sensing that there is a valid signal in a channel among the nodes checking a channel usage state at different intervals, receiving a short preamble transmitted by a second node emitting the valid signal among the nodes;
maintaining a sleep mode for a duration corresponding to a remainder of the long preamble at a time position of the short preamble; and
when the sleep mode duration is passed, acquiring data from the short preambles generated according to a type of data to be transmitted,
wherein the second node determines a total length of the long preamble on the basis of traffic information of its neighbouring nodes.

10. The method of claim 9, wherein the acquiring of the data comprises:
when the sleep mode duration is passed, checking a type of the short preamble;
when the type of the short preamble is a type used to transmit transmission data subsequent to the long preamble, checking whether a destination address is an address of the first node;
when the destination address is the address of the first node, receiving the transmission data; and
when the destination address is not the address of the first node, maintaining the sleep mode for a duration corresponding to a length of the transmission data.

11. The method of claim 9, wherein the acquiring of the data comprises:
when the sleep mode duration is passed, checking a type of the short preamble; and
when the type of the short preamble is a type used to exchange or update traffic information, acquiring the traffic information from the short preamble.

12. The method of claim 10, further comprising, when acquiring upward traffic or downward traffic change information from the received short preamble or when traffic which the first node generates is changed, changing a channel check interval on the basis of the changed traffic.

13. A method of controlling media access in a sensor network including sensor nodes transmitting and receiving information by using a long preamble consisting of consecutive short preambles, the method comprising:
sensing whether there is a valid signal in a channel by checking a channel usage state at first channel check intervals;
when there is no valid signal in the channel, requesting downward traffic to neighbouring nodes by using a long preamble with a greatest length among usable preamble lengths;
receiving a short preamble including the downward traffic from a neighbouring node receiving a short preamble of the long preamble with the greatest length; and
setting a second channel check interval by using the downward traffic and upward traffic.

14. The method of claim 13, wherein the first channel check interval is a shortest channel check interval among the usable channel check intervals.

15. The method of claim 13, wherein, as a sum of the amount of the downward traffic and the amount of the upward traffic increases, the second channel check interval decreases.

16. The method of claim 13, further comprising, when the second channel check interval is changed by a change in the upward traffic, notifying the change in the upward traffic to the neighbouring nodes by using a long preamble with a length corresponding to a channel check interval of a node with least traffic among the neighbouring nodes.

17. The method of claim 13, before the setting of the second channel check interval, the method further comprising:
when an upward traffic change or update message is received, updating traffic information of a traffic table in which traffic information of the neighbouring nodes is matched with node addresses and hierarchical level information and then stored; and
when a downward traffic change message is received, transmitting a downward traffic update message to the neighbouring nodes.

18. The method of claim 13, wherein the receiving of the short preamble comprises receiving a short preamble from a neighbouring node while waiting for a longest channel check interval.

19. An apparatus for controlling media access of a sensor node in a sensor network including sensor nodes transmitting and receiving information by using a long preamble consisting of consecutive short preambles, the apparatus comprising:
a monitor sensing whether there is a valid signal in a channel by checking a channel usage state at predetermined intervals;
a preamble generating unit determining, when there is no valid signal in the channel and there is data to be transmitted, a length of the long preamble on the basis of traffic information of one or more receiver nodes and consecutively generating one or more short preambles corresponding to the determined length of the long preamble according to a type of the data to be transmitted; and
a transmitting unit transmitting the short preambles to the receiver nodes.

20. The apparatus of claim 19, wherein the preamble generating unit comprises:
a searching unit searching for traffic information of the receiver nodes in a traffic table in which traffic information of neighbouring nodes is matched with node addresses and hierarchical level information and then stored; and
a length determining unit determining a greatest length among usable preamble lengths as a length of the long preamble when there is no traffic information of the receiver nodes in the traffic table, and determining a length of the long preamble on the basis of a channel check interval of a receiver node with least traffic when there is the traffic information of the receiver nodes in the traffic table.

21. The apparatus of claim 19, wherein the preamble generating unit,
when the data to be transmitted is traffic information to be exchanged or updated, generates a first short preamble including traffic information, and
when the data to be transmitted is transmission data transmitted subsequent to the long preamble, generates a second short preamble including length information of the transmission data.

22. The apparatus of claim 20, wherein the traffic table is updated with traffic information obtained by short preambles received from the neighbouring nodes.

23. The apparatus of claim 19, further comprising:
a receiving unit receiving a short preamble transmitted by a node emitting the valid signal to the channel; and
a parsing unit maintaining a sleep mode for a duration corresponding to a remainder of the long preamble at a time position of the short preamble, and when the sleep mode duration is passed, acquiring data transmitted according to a type of the short preamble,
wherein a total length of the long preamble is determined by the node emitting the valid signal on the basis of traffic information of its neighbouring nodes.

24. The apparatus of claim 23, further comprising a check interval determining unit, when upward or downward traffic change information is acquired from the received short preamble or when its own generated traffic is changed, changing a channel check interval on the basis of the changed traffic.

25. The apparatus of claim 23, wherein the parsing unit, when the type of the short preamble is a type used to transmit transmission data and a destination address is its own address, receives the transmission data transmitted subsequent to the long preamble, and when the type of the short preamble is a type used to transmit transmission data and a destination address is not its own address, maintains a sleep mode for a duration corresponding to a length of the transmission data, and
when the type of the short preamble is a type used to exchange or update traffic information, acquires the traffic information from the short preamble.
